(19) United States
(12) Patent Application Publication
(10) Pub. No.: US 2004/0026567 A1
(43) Pub. Date: Feb. 12, 2004

(54) Fluid delivery system for heat exchange garments

(76) Inventor: Sam Emmerling, North Little Rock, AR (US)

Correspondence Address: Mark Rogers, Speed & Rogers, P.A., Suite 125, 1701 Centerview, Little Rock, AR, 72211, US

(21) Appl. No.: 10/215,428

(22) Filed: Aug. 9, 2002

(51) Int. Cl. B64D 11/00; B64D 13/00

(52) U.S. Cl. 244/118.5

(57) ABSTRACT

The present system uses a heat exchanger to heat or cool a fluid for circulation through a heat exchange garment. A main feed line, flow control valve, and main return line provide continuous circulation of a fluid. Multiple branch feed lines operably connect multiple heat exchange garments to the main feed line, and multiple branch return lines operably connect those garments to the main return line. The main feed line and main return line are suspended overhead, and branch feed and return lines are affixed to elevated portions of support members to keep tubes and lines up and out of the way. The support member may be an infinitely rotatable support member allowing tangle free rotation of greater than 360°. Individual flow control valves may be disposed at each work site. Also, separate sources of hot and cold fluids may be provided at each work site.

### BACKGROUND OF THE INVENTION

This invention relates to heat exchange garments and more particularly to fluid delivery systems for providing cooling and heating fluid to heat exchange garments.

Heat exchange garments are known. A heat exchange garment typically comprises material fashioned as a garment with tubing affixed thereto. The tubing typically has a connector, such as a drip-free, quick coupling device for operably connecting the garment to a fluid source, such as heated or cooled water. Depending on whether the water is hot or cold, as the water passes through the tubing affixed to the material, the water either warms or cools a user wearing the garment. These garments are particularly suited for use in extremely hot or cold environments, often in harsh conditions. For example, they have been adapted for use by astronauts and firemen and have been adapted for use by people who must wear hot, heavy, protective gear in hot conditions, such as might be encountered by individuals involved in hazardous material clean-up or by military personnel in response to chemical warfare attacks. These garments have most often been used in constantly changing locations, so significant efforts have been made to improve the portability of the garment and fluid delivery system.

In one of the most common configurations, the heat exchange garment and the fluid delivery system are worn by the user. The fluid delivery system is carried primarily in a backpack type device. The backpack may carry a power supply, such as a battery, a small pump, and an insulated container that is periodically charged with ice and water. Cold water from the insulated container is pumped through the tubing affixed to the garment and returned to the insulated container. As the cold water passes through the tubing, it removes heat from the user wearing the garment. Ice in the insulated container cools the returned water and, in doing so, slowly melts. As the ice melts, the cooling capacity of the garment diminishes. As desired, additional ice is added to the insulated container. These devices are useful in a number of situations, particularly when the user must move about a large, often unpredictable, area and when the user does not need to wear the garment for an extended period of time. Still, these devices suffer from a number of disadvantages. For example, the backpacks are often heavy and uncomfortable, particularly if they must be worn for extended periods of time. They also typically interfere with or slow free movement of the user's body. The desire to reduce the weight of the backpack can also lead to batteries that are too small or too few to provide the power desired, pumps that are too small or too weak to provide the flow rates or pressures desired, and insulated containers that are too small to hold sufficient ice and water to provide sufficient cooling capacity for extended periods of time. It can also be inconvenient and messy to maintain a supply of ice for recharging the insulated containers, and it can be inconvenient, messy, and unsafe to have to stop and recharge or refill the insulated containers from time to time. Further, these portable garments also typically require a separate fluid delivery system for each heat exchange garment. To outfit several users would therefore require several backpacks, several pumps, several sets of batteries, several insulated containers, and several supplies of ice and water.

Portable systems are also known in which the fluid delivery systems are not worn by the users. In one such common system an insulated container about the size of a large ice chest is used. A pump and power supply are affixed to the insulated container, and one or more connectors are provided at the insulated container for connecting one or more heat exchange garments to the fluid delivery system. The tubing of the heat exchange garments typically include short tether sections of approximately 10 feet or less with connectors at the end for coupling with the fluid delivery system. The tether sections typically drag along the ground behind the user. These portable systems suffer from many of the same disadvantages as the worn systems discussed above. For example, the insulated containers typically must be recharged with ice from time to time. Similar to the worn system, the desire for mobility can still lead to a battery pack or a power supply that is too small or too under-powered to provide the power desired, a pump that is too small or too weak to provide the flow rates or pressures desired, and an insulated container that is too small to hold sufficient ice and water to provide sufficient cooling capacity for extended periods of time. These systems also suffer from additional disadvantages. For example, the short tethers used significantly limit the mobility of the users and require the users to remain in relatively close proximity to the insulated container and to each other. Dragging multiple tethers along the ground behind different users can also present problems. The tethers can get in the way and interfere with movement of the users. Dragging a tether along the ground also increases the risk that the tether may be damaged or become pinched, snagged, or entangled with other obstacles on or near the ground. These systems also typically do not allow multiple users much freedom to vary fluid flow rates for different heat exchange garments connected to the same insulated container. Some efforts have been made to allow some individual control of flow rates to individual heat exchange garments, but these systems have largely been inflexible, inconvenient, or cumbersome and have typically required a user to return to the insulated container or heat exchanger to make any change or adjustment.

### SUMMARY OF THE INVENTION

It is therefore an object of the present invention to provide a fluid delivery system and heat exchange garment that is particularly suited for industrial or workplace applications.

It is a further object of the present invention to provide a fluid delivery system and heat exchange garment of the above type that is particularly suited for recreational applications.

It is a further object of the present invention to provide a fluid delivery system and heat exchange garment of the above type that is particularly suited for medical applications, particularly emergency medical situations involving heat or cold stress.

It is a further object of the present invention to provide a fluid delivery system and heat exchange garment of the above type that provides a continuously circulating supply of heating or cooling fluid to heat exchange garments worn by multiple users in multiple locations.

It is a still further object of the present invention to provide a fluid delivery system and heat exchange garment of the above type that provides great flexibility and individual control to each individual user.

It is a still further object of the present invention to provide a fluid delivery system and heat exchange garment of the above type that provides for individual controls that are conveniently located at each particular work site.

It is a still further object of the present invention to provide a fluid delivery system and heat exchange garment of the above type that is particularly suited for use in a workplace environment with multiple fixed workstations.

It is a still further object of the present invention to provide a fluid delivery system and heat exchange garment of the above type that is particularly suited for providing a continuous supply of a heating or cooling fluid at a steady temperature over an extended period of time.

It is a still further object of the present invention to provide a fluid delivery system and heat exchange garment of the above type that increases the mobility of a user about a predefined area.

It is a still further object of the present invention to provide a fluid delivery system and heat exchange garment of the above type that keeps fluid lines and tubes off the ground and out of the way.

It is a still further object of the present invention to provide a fluid delivery system and heat exchange garment of the above type that provides quick and easy attachment and adjustment at each work site.

It is a still further object of the present invention to provide a fluid delivery system and heat exchange garment of the above type that provides separate connectors with hot and cold fluids at each work site for greater flexibility in maintaining multiple users comfortable in a workplace that may have both cold and hot work sites.

It is a still further object of the present invention to provide a fluid delivery system and heat exchange garment of the above type that provides an elevated, infinitely rotatable support for maintaining lines and tubes of the fluid delivery system and heat exchange garment up and out of the way while providing great flexibility in user movement about a predefined work site.

It is a still further object of the present invention to provide a fluid delivery system and heat exchange garment of the above type to provide a continuously circulating fluid source across an extended area remote from the heat exchanger for quickly supplying cooling or heating fluid to multiple work sites disposed remotely from the heat exchanger and from each other.

It is a still further object of the present invention to provide a fluid delivery system and heat exchange garment of the above type to provide a higher pressure main feed line for supplying multiple heat exchange garments with fluid at lower pressures better suited for the construction of the garments.

Toward the fulfillment of these and other objects and advantages, the present system uses a heat exchanger to heat or cool a fluid for circulation through a heat exchange garment. A main feed line, flow control valve, and main return line provide continuous circulation of a fluid. Multiple branch feed lines operably connect multiple heat exchange garments to the main feed line, and multiple branch return lines operably connect those garments to the main return line. The main feed line and main return line are suspended overhead, and branch feed and return lines are affixed to elevated portions of support members to keep tubes and lines up and out of the way. The support member may be an infinitely rotatable support member allowing tangle free rotation of greater than 360°. Individual flow control valves may be disposed at each work site. Also, separate sources of hot and cold fluids may be provided at each work site.

### BRIEF DESCRIPTION OF THE DRAWINGS

The above brief description, as well as further objects, features and advantages of the present invention will be more fully appreciated by reference to the following detailed description of the presently preferred but nonetheless illustrative embodiments in accordance with the present invention when taken in conjunction with the accompanying drawings, wherein:

FIG. 1 is a schematic view of a system of the present invention;

FIG. 2 is a perspective view of one embodiment of a system of the present invention;

FIG. 3 is a partial, side elevation view of one embodiment of a support member of the present invention;

FIG. 4 is a partial, exploded, side elevation view of an alternate embodiment of the present invention;

FIG. 5 is a perspective view of a portion of an alternate embodiment of a system of the present invention; and

FIGS. 6-8 are schematic views of alternate embodiments of a system of the present invention.

### DETAILED DESCRIPTION OF THE PREFERRED EMBODIMENT

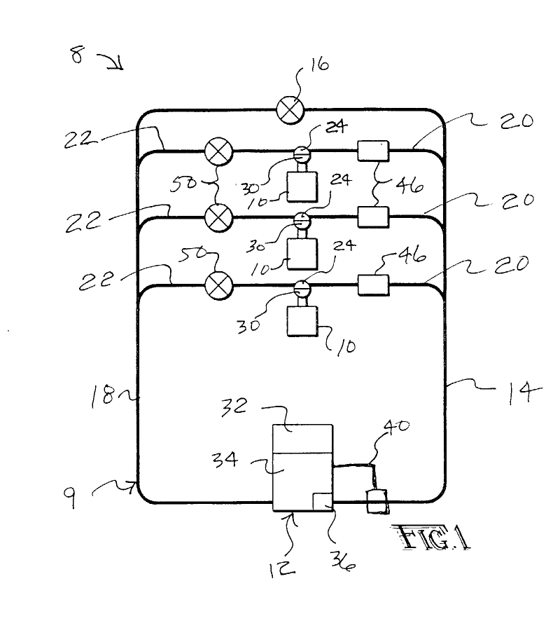

Referring to FIG. 1, the reference numeral 8 refers in general to a combination of the present invention. The combination may comprise a fluid delivery system 9 and a heat exchange garment 10. The fluid delivery system 9 may comprise a heat exchanger 12, a main feed line 14, a bypass or flow control valve 16, a main return line 18, one or more branch feed lines 20, one or more branch return lines 22, and one or more connectors 24. The heat exchange garment 10 may comprise material 26, tubing 28, and a connector 30.

The heat exchanger 12 is preferably a substantially immobile, continuously operating heat exchanger, such as a common water chiller or water heater. If the heat exchanger 12 is a water chiller, it will typically have a powered cooling element 32 including a compressor, an expansion valve, hot side and cold side tubing forming a loop with the compressor and expansion valve, a tank or reservoir 34, and a pump 36. Water in the reservoir 34 is in a heat exchange relationship with the cold side tubing to cool the water in the reservoir 34. The water chiller is preferably sized so that it is rated at least approximately ½ ton and 6000 BTU. For larger applications, the chiller is more preferably sized so that it is rated at least approximately 1.5 ton and 18,000 BTU, at least approximately 3 ton and 36,000 BTU, or at least approximately 5 ton and 60,000 BTU, depending upon the sizing and the demands to be placed on the system. If the heat exchanger 12 is a water heater, it will typically include a tank or reservoir 34, a burner or heating element, and a pump 36. Water in the reservoir 34 is in a heat exchange relationship with the burner or heating element. The heat exchanger 12 may also be a reverse cycle chiller so that a single unit may be used to provide heating or cooling. The pump 36 has a horsepower rating that is preferably greater than or equal to approximately ⅓ hp and is capable of providing a flow rate that is preferably greater than or equal to approximately 6 gallons per minute. For larger applications, the pump 36 has a horsepower rating that is preferably greater than or equal to approximately ½ hp or that is greater than or equal to approximately ¾ hp and is capable of providing a flow rate that is preferably greater than or equal to approximately 20 gallons per minute. As described in more detail below, a back pressure regulator 38 and bypass line 40 may be provided to allow water to be returned to the reservoir 34 without passing through the branch feed and return lines and heat exchange garments 10. It is of course understood that the back pressure regulator 38 may be disposed in any number of locations, and the bypass line 40 may also pass the water to main return line 18 or to any number of different locations at or near the reservoir 34. The heat exchanger 12, including the pump 36, is preferably powered by electricity, typically by simply plugging it into the existing electrical system of the building in which it is housed. As discussed in more detail below, the components of the heat exchanger 12, such as the compressor and pump 36, are sized depending upon factors such as the size of the system, the number of users 41, and whether the heat exchanger 12 forms part of a fixed or mobile system. The heat exchanger 12 is preferably a powered unit, such as a common water chiller or water heater, but it may take any number of different forms. For example, the cooling or heating force or bank may be supplied by something as simple as a container housing a hot or cold element, such as an insulated container with ice.

The main feed line 14 and main return line 18 are preferably a ¾″ composite pipe such as Kitec® brand composite pipe having an aluminum core bonded to interior and exterior layers of plastic. The main feed line 14 and main return line 18 preferably have lengths that are equal to or greater than approximately 12 feet and that are more preferably equal to or greater than approximately 50 feet. For even larger applications, the main feed line 14 and main return line 18 may have lengths that are greater than or equal to approximately 100 feet, greater than or equal to approximately 300 feet, greater than or equal to approximately 400 feet, or greater than or equal to approximately 1,000 feet. The main feed line 14 and main return line 18 are operably connected to the reservoir 34 of the heat exchanger 12 so that they are in fluid flow communication therewith. It is understood that the lines need not be actually physically connected directly to the reservoir 34 housing, so long as a path is provided for fluid to pass from the reservoir 34 to the main feed line 14 and from the main return line 18 to the reservoir 34. It is of course understood that there may be any number of lines, pipes, valves, and the like disposed between these or other components of the combination or forming part of those components. An inline filter is included in the main return line 18 near the heat exchanger 12. It is also understood that any line, hose, tube, conduit, or the like may have a contiguous body or may be formed from a number of different segments or components.

The flow control valve 16 is disposed at an elevated position, preferably affixed to or suspended from the ceiling 42, and is disposed remotely from the heat exchanger 12. The flow control valve 16 is disposed at a height that is preferably greater than or equal to approximately 5 feet, that is more preferably greater than or equal to approximately 6 feet, and that is most preferably greater than or equal to approximately 8 feet. The flow control valve 16 is preferably disposed at a distance from the heat exchanger 12 that is greater than or equal to approximately 12 feet, that is more preferably greater than or equal to approximately 15 feet, and that is most preferably greater than or equal to than approximately 50 feet. For even larger applications, the flow control valve 16 may be disposed at a distance from the heat exchanger 12 that is greater than or equal to approximately 300 feet, greater than or equal to approximately 400 feet, or greater than or equal to approximately 1,000 feet. The main feed line 14 and main return line 18 are operably connected to the flow control valve 16 so that water may pass from the main feed line 14, through the flow control valve 16, and into the main return line 18. As described in more detail below, the flow control valve 16 partially restricts flow from the main feed line 14 to the main return line 18. Although it is preferred to use a flow control valve 16, it is understood that a flow control valve is not required.

The main feed line 14 and main return line 18 have elevated portions having lengths that are preferably greater than or equal to approximately 5 feet, that are more preferably greater than or equal to approximately 20 feet, and that are most preferably greater than or equal to approximately 50 feet. The elevated portions are preferably affixed to or suspended from a ceiling 42 at a height that is selected so that the main feed line 14 and main return line 18 are disposed overhead. The elevated portions preferably have heights that are preferably greater than or equal to approximately 5 feet, that are more preferably greater than or equal to approximately 6 feet, and that are most preferably greater than or equal to approximately 8 feet. It is understood that, unless otherwise specified, the heights mentioned herein are measured from the ground, floor, or other surface on which a user 41 wearing a heat exchange garment 10 would stand or on which the user's feet would rest while seated 44. Of course any number of different types and sizes of pipes, hoses, tubing may be used. As discussed in more detail below, the lengths and sizes of the main feed line 14 and main return line 18 depend upon the size and characteristics of the desired system, and the components are sized depending upon the desired characteristics of the system. For ease and clarity of presentation, the schematic depiction in FIG. 1 shows the main feed line 14 and main return line 18 separated. The main feed line 14 and main return line 18 are preferably routed side by side, but it is understood that they may be independently routed as desired without regard to the routing of the other. Further, although it is preferred to use flow control valve 16, no flow control valve is required. In fact, the main feed line 14 and main return line 18 need not be operably connected at their ends and may be operably connected only via the branch feed and return lines 20 and 22 and heat exchange garments 10. It is preferred to provide for circulation regardless of whether any heat exchange garment 10 is connected and allowing fluid flow, but that is not required.

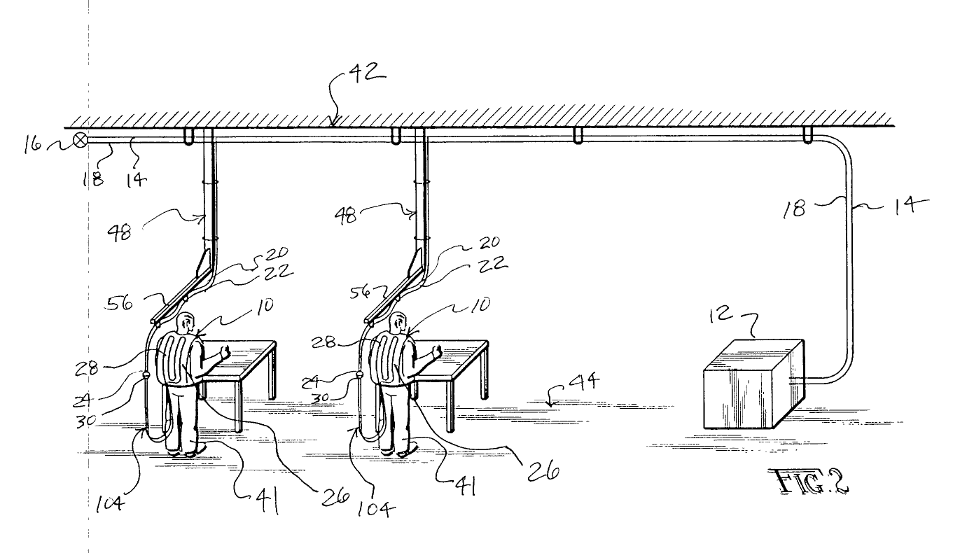

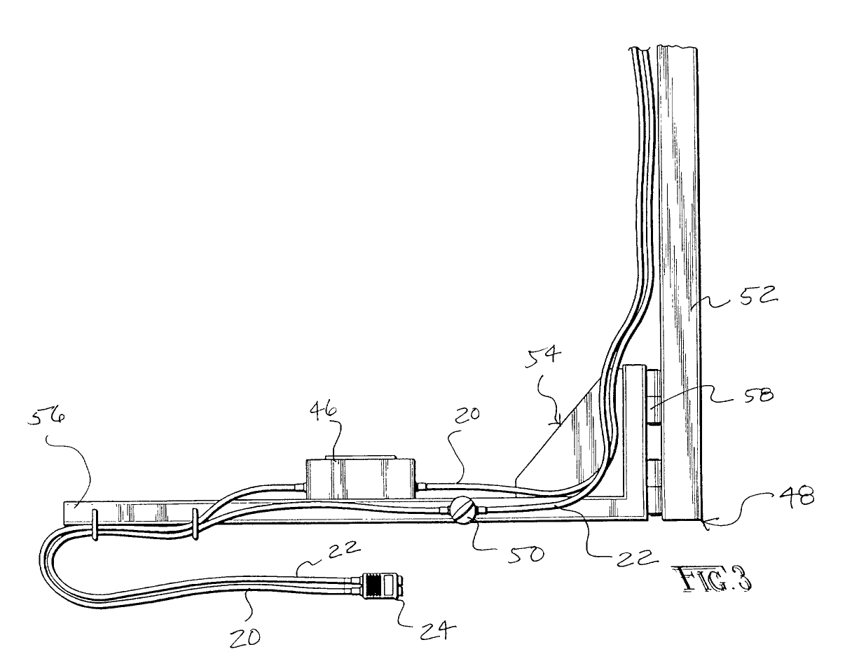

The branch feed lines 20 and branch return lines 22 are preferably ¼″ polyethylene tubing. Each branch feed line 20 is secured to and extends between the main feed line 14 and a heat exchange garment 10, operably connecting the main feed line 14 to the heat exchange garment 10. A pressure regulator 46 is disposed along or operably connected to the branch feed line 20. As best seen in FIGS. 2 and 3, the branch feed line 20 is affixed to an elevated portion of a support member 48. The elevated portion of the support member 48 is disposed at a height that is preferably greater than or equal to approximately 5 feet, that is more preferably greater than or equal to approximately 6 feet, and that is most preferably greater than or equal to approximately 6′6″. A discharge end of the branch feed line 20 is operably connected to a quick coupling connector 24, such as the quick coupling connector described in U.S. Pat. No. 6,302,147, issued to Rose et al. in 2001, the disclosure of which is incorporated herein by reference. An inline filter is preferably included in the branch feed line 20 upstream of the connector 24.

Each branch return line 22 is secured to and extends between the heat exchange garment 10 and the main return line 18, operably connecting the heat exchange garment 10 to the main return line 18. A flow control valve 50 is disposed along or operably connected to the branch return line 22. As best seen in FIGS. 2 and 3, like the branch feed line 20, the branch return line 22 is affixed to an elevated portion of the support member 48. An intake end of the branch return line 22 is operably connected to the quick coupling connector 24. For ease and clarity of presentation, the schematic depiction in FIG. 1 shows the branch feed lines 20 and branch return lines 22 separated. As seen in FIG. 2, each pair of branch feeds lines 20 and branch return lines 22 are preferably routed side by side, but it is understood that they may be independently routed as desired without regard to the routing of the other.

As seen in FIGS. 3-5, the support member 48 preferably has a stationary section 52 and a movable section 54 rotatably secured to the stationary section 52. The stationary section 52 may be suspended from the ceiling 42 or a wall or may be supported on the floor 44. Referring to FIG. 3, the movable section 54 may take the form of a substantially horizontal, rigid, elongate member 56 that is affixed to the stationary section 52 by a hinge 58 for rotation about a substantially vertical axis. At least a portion of the elongate member 56 forms a part of the elevated portion of the support member. Accordingly, at least a portion of the elongate member 56 is disposed at a height that is preferably greater than or equal to approximately 5 feet, that is more preferably greater than or equal to approximately 6 feet, and that is most preferably greater than or equal to approximately 6′6″. The pressure regulator 46 and flow control valve 50 are preferably secured to the branch feed line 20 and branch return line 22 at locations in which they may also be supported by the elongate member 56. The lengths of the branch feed line 20 and branch return line 22 are selected so that the connector 24 may hang a distance below the elongate member 56. The distance is preferably greater than or equal to approximately 1 foot, is more preferably greater than or equal to approximately 2 feet, and is most preferably greater than or equal to approximately 3 feet.

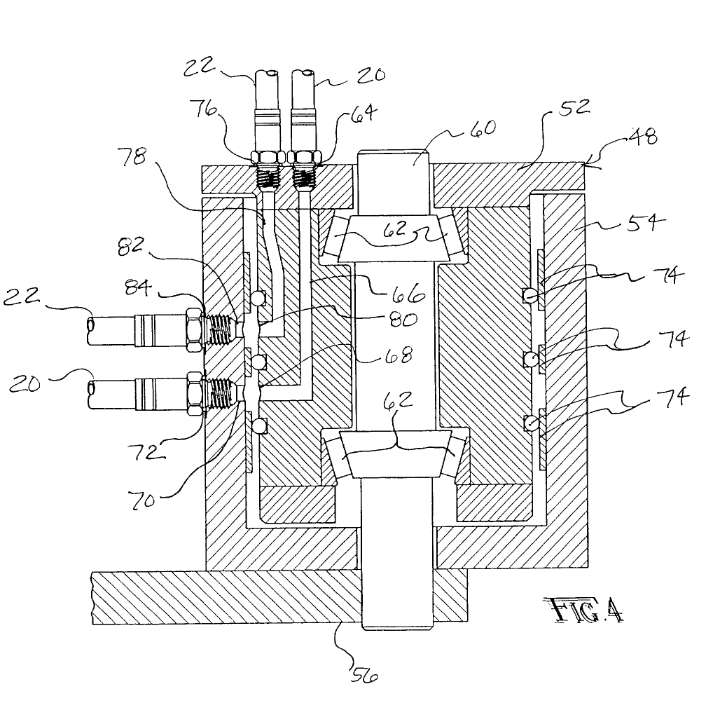

FIG. 4 depicts an alternate embodiment of a support member 48 of the present invention that allows for infinite rotation of the movable section 54 relative to the stationary section 52 without tangling of the branch feed line 20 or branch return line 22. The stationary section 52 is supported in a fixed position relative to a work site. The movable section 54 is connected thereto for infinite rotation about a substantially vertical axis in a manner similar to the infinitely rotating welding head disclosed in U.S. Pat. No. 4,791,270, issued to Nelson Jr., et al., the disclosure of which is incorporated herein by reference. Shaft 60 is coaxially aligned with the stationary section 52 and is supported for rotation relative to the stationary section 52 by bearings 62. A rotating outer cylinder 54 is rigidly affixed to the shaft 60 for infinite rotation relative to the stationary section 52. A rigid, substantially horizontal elongate member 56 is also rigidly affixed to the shaft 60 or to the rotating outer cylinder for infinite rotation relative to the stationary section 52 as well. Branch feed line 20 is connected to input opening 64 in the stationary section 52, and a conduit 66 provides a path to an opening in a lower, side portion of the stationary section 52. A groove or channel 68 is provided in the stationary section 52 or in the outer cylinder, aligned with the opening in the lower, side portion of the stationary section 52. A conduit 70 through the outer cylinder provides a path from the groove 68 to an opening 72 on an outer surface of the rotating cylinder 54. In this manner, stationary section 52 and movable section 54 of the support member 48 define a feed path extending between the input opening 64 of the stationary section 52 and the opening 72 of the movable section 54. O-rings, compression rings, and other sealing elements 74 may be disposed between the stationary section 52 and the rotating cylinder 54 to form seals to prevent fluid from escaping from the feed path. Branch feed line 20 is connected to the opening 72. From the outer cylinder 54, the branch feed line 20 passes to and is affixed to the elongate member 56 and on to the connector 24 for coupling with the heat exchange garment 10 much like the embodiment shown in FIGS. 2 and 3.

A return path is provided in much the same manner as the feed path. Branch return line 22 is connected to discharge opening 76 in the stationary section 52, and a conduit 78 provides a path to an opening in a lower, side portion of the stationary section 52. A groove or channel 80 is provided in the stationary section 52 or in the outer cylinder 54, aligned with the opening in the lower, side portion of the stationary section 52. A conduit 82 through the outer cylinder 54 provides a path from the groove 80 to an opening 84 on an outer surface of the rotating cylinder 54. In this manner, stationary section 52 and movable section 54 of the support member 48 define a return path extending between the discharge opening 76 of the stationary section 52 and the opening 84 of the movable section 54. O-rings, compression rings, and other sealing elements 74 may be disposed between the stationary section 52 and the rotating cylinder 54 to form seals to prevent fluid from escaping from the return path. Branch return line 22 is connected to the opening 84. From the outer cylinder 54, the branch return line 22 passes to and is affixed to the elongate member 56 and on to the connector 24 for coupling with the heat exchange garment 10 much like the embodiment shown in FIGS. 2 and 3.

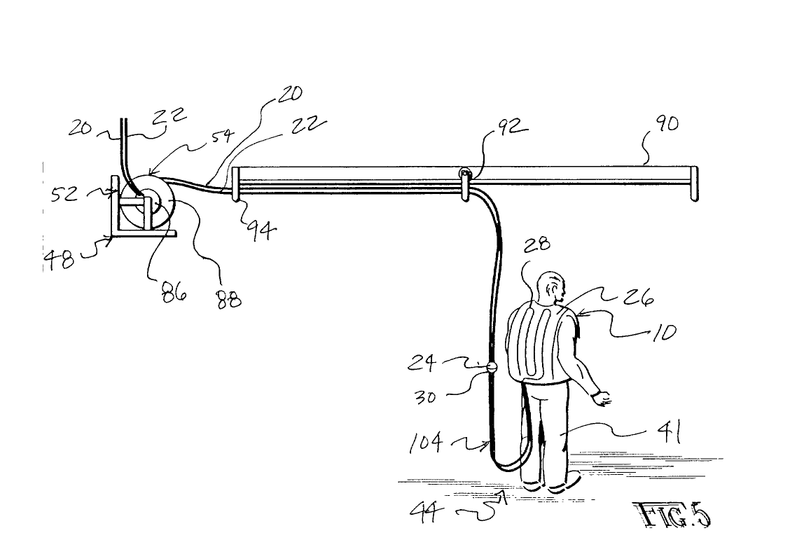

FIG. 5 depicts an alternate embodiment of a support member 48 of the present invention that also allows for rotations of the movable section 54 of much greater than 360° relative to the stationary section 52 without tangling of the branch feed line 20 or branch return line 22. The stationary section 52 is supported in a fixed position relative to a work site. The movable section 54 is connected thereto for rotation about a substantially horizontal axis in a manner similar to a garden hose reel or the infinitely rotating welding head disclosed in U.S. Pat. No. 4,791,270, issued to Nelson Jr., et al. The stationary section 52 includes a substantially horizontal drum section 86. A branch feed line 20 and branch return line 22 are connected to openings in the drum 86. The movable section 54 comprises a reel 88 that is coaxially aligned with the drum 86 and is rotatably secured thereto for rotation about a substantially horizontal axis. A branch feed line 20 and branch return line 22 are connected to openings in the outer surface of the reel 88, and the reel 88 and drum 86 define a feed path and a return path similar to the feed path and return path discussed above in connection with FIG. 4. The branch feed line 20 and branch return line 22 are relatively long and are coiled onto the reel 88 much like a garden hose on a garden hose reel. The portions of the branch feed line 20 and branch return line 22 affixed to the reel 88 preferably have lengths that are greater than or equal to approximately 20 feet, that are more preferably greater than or equal to approximately 50 feet, and that are most preferably greater than or equal to approximately 200 feet. The reel 88 is spring biased to provide a winding force.

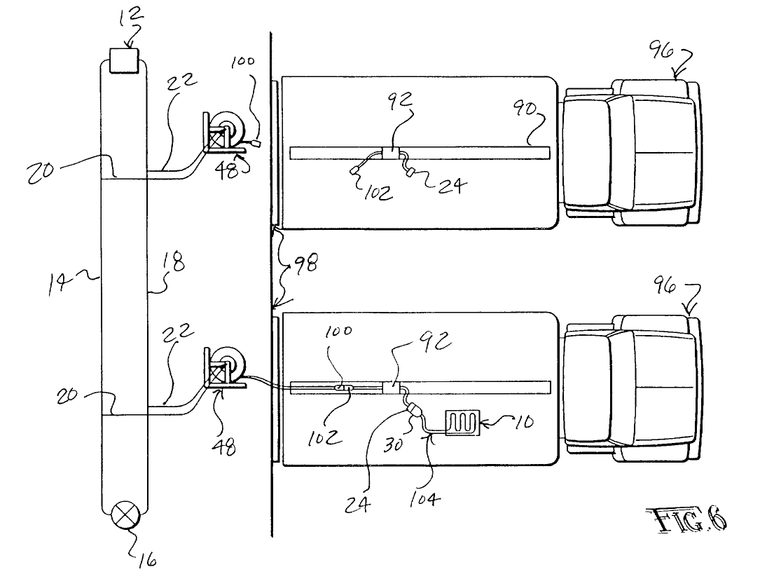

The reel 88 type support may be used alone or in any number of combinations with other supports. For example, as shown in FIG. 5, a rail 90 may be provided, preferably disposed in an elevated position. A rolling or sliding support member 92 is movably supported within the rail 90. The branch feed line 20 and branch return line 22 pass over one or more bars 94 and are secured to the support member 92. The branch feed line 20 and branch return line 22 support a connector 24 a distance below the support member 92 for connection to the connector 30 of a heat exchange garment 10. The rail 90 may be affixed to or suspended from the ceiling 42 at the work site. As seen in FIG. 6, the rail 90 may also be affixed to the roof or ceiling of trucks, vehicles, or other mobile objects 96 that are moved into and out of position at a loading dock or similar facility 98. If the rail 90 is mobile relative to the reel 88, additional connectors 100 and 102 may be used to allow the reel 88 to be used in connection with different rails of different vehicles or the like at different times. As can be appreciated from the different embodiments discussed above, the support member 48 may take any number of different shapes, sizes, and configurations. It may be something as simple as a cord or line of sufficient strength to support the branch feed line 20 or branch return line 22 in an elevated position or as complex as the infinitely rotating support. It is also understood that the different embodiments and features of the different support members may be combined in any number of different ways. For example, a drum 86 and reel 88 may be affixed to an elongate member 56 that is rotatably affixed to a stationary member 52 similar to the elongate members 56 shown in FIGS. 3 and 4, or a rotating elongate member 56 similar to those shown in FIGS. 3 and 4 may be affixed to a support member 92 disposed in a rail 90 similar to that shown in FIGS. 5 and 6. Further, an infinitely rotating support member 48 such as the one shown in FIG. 4 may be used without an elongate member 56.

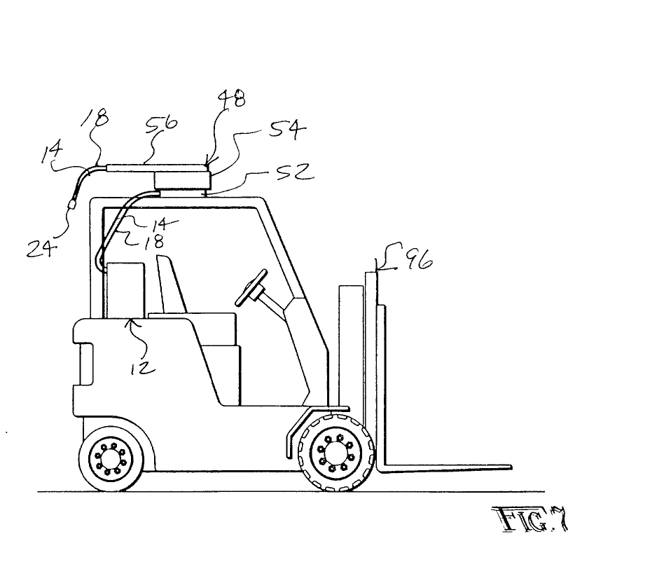

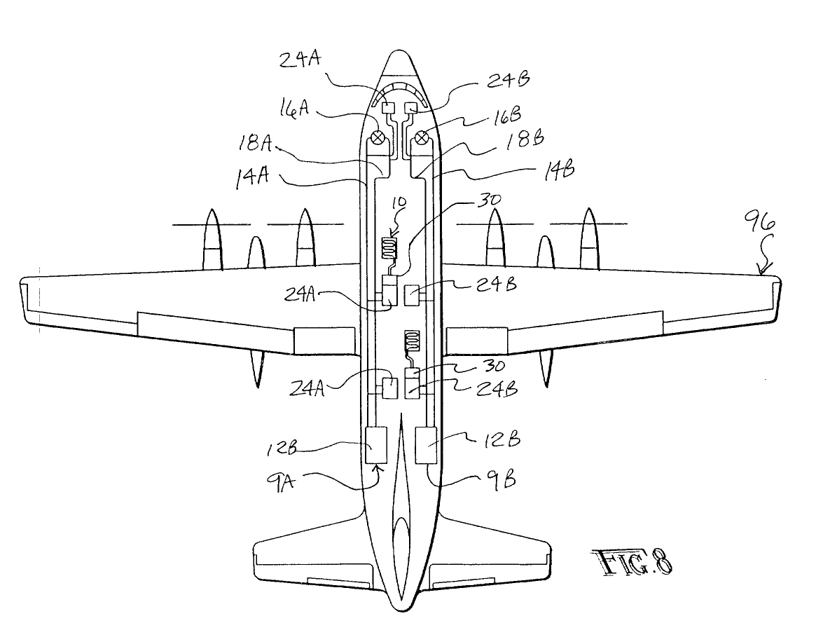

As seen in the alternate embodiments depicted in FIGS. 7 and 8, the fluid delivery system 9 may be disposed on any number of different vehicles, boats, aircraft, and similar mobile objects 96, including but not limited to the forklift depicted in FIG. 7, the C-130 aircraft depicted in FIG. 8, a golf cart, an ambulance, and a fishing boat. In these embodiments, the heat exchanger 12, including the reservoir 34 and pump 36, and the support member 48, if needed, are affixed to the mobile object 96. Such a fluid delivery system 9 may be designed to support only one heat exchange garment 10 (FIG. 7) or to support any number of heat exchange garments 10 (FIG. 8). As best seen in FIG. 7, if only one heat exchange garment 10 is to be used, branch feed and return lines 20 and 22 are not needed, so the main feed line 14 and main return line 18 may extend between the heat exchange garment 10 and the heat exchanger 12. A support member 48, such as an infinitely rotating support member, may be positioned on a roof or other out of the way place on the mobile object 96.

The heat exchange garment 10 may take any number of shapes, sizes and configurations. Heat exchange garments 10 are well known in the art and generally comprise a material 26 adapted to be worn by or placed on a user 41, a connector 30, and a cooling or heating tube 28. The tube 28 has a feed end, a return end, and an intermediate portion. The feed and return ends are affixed to the connector 30, and the intermediate portion is affixed to the material 26, routed to provide heat exchange with desired portions of the user's body. The garment 10 may be formed as any number of different articles to be worn by or placed on a user 41. For example, the garment 10 might be formed as a vest, a full body suit, a pair of pants, a shirt, a coat, shoes, gloves, headgear, a poncho, a blanket, or the like. Heat exchange garments 10 are well known in the art and will not be described in great detail here. Descriptions of various embodiments of heat exchange garments 10 may be found in patents such as U.S. Pat. No. 3,400,756, issued to Cogswell in 1966, U.S. Pat. No. 3,425,486, issued to Burton et al. in 1966, U.S. Pat. No. 5,755,275, issued to Rose et al. in 1998, and U.S. Pat. No. 6,349,412, issued to Dean in 2002. The disclosures of these patents are incorporated herein by reference.

The portion of the tubing 28 extending from the material 26 to the connector 30 is typically considered a tether portion 104. The length of the tether portion 104 is selected to allow some degree of mobility and freedom of movement. Of course, it is understood that the mobility and freedom of movement may be provided by the tether portion 104, by the selected length of the branch feed line 20 and return line 22, by the action of the support member 48, or by any number of combinations of these items. While it is preferred that the heat exchange garment 10 have a connector 30 so that it may be quickly and easily connected to and disconnected from the fluid delivery system 9, it is understood that the branch feed line 20 and branch return line 22 may be affixed directly to and be contiguous with the tubing 28 of the heat exchange garment 10.

The following describes operation of one embodiment of the present invention, a fixed system for supplying cooling fluid to up to six heat exchange garments 10 at a location such as a laundromat. A ½ ton, 6,000 BTU water chiller is used as the heat exchanger 12. A ⅓ hp pump 36 with a maximum flow rate of approximately 6 gallons per minute is used. The water chiller is turned on, and the cooling coils cool the water in the reservoir 34 to a temperature that is preferably substantially within a range of from approximately 80° F. to approximately 33° F., that is more preferably substantially within a range of from approximately 70° F. to approximately 40° F., and that is most preferably substantially within a range of from approximately 50° F. to approximately 45° F. The pump 36 is activated and pumps the cooled water through the main feed line 14. The discharge pressure at the pump 36 is preferably greater than or equal to approximately 15 psig, is more preferably greater than or equal to approximately 25 psig, and is most preferably greater than or equal to approximately 30 psig. This corresponds to the maximum pressure in the main feed line 14.

The lengths of the main feed line 14 and main return line 18 may extend up to approximately 100 feet. The flow control valve 16 restricts the flow of the water from the main feed line 14 to the main return line 18 so that approximately 1 gallon per minute passes from the main feed line 14, through the flow control valve 16, and into the main return line 18. The maximum pressure in the main feed line 14 is preferably greater than or equal to approximately 15 psig, is more preferably greater than or equal to approximately 25 psig, and is most preferably greater than or equal to approximately 30 psig. The maximum pressure in the main return line 18 is preferably less than or equal to approximately 15 psig, is more preferably less than or equal to approximately 10 psig, and is most preferably less than or equal to approximately 8 psig. The back pressure regulator 38 and bypass line 40 return the remaining flow capacity of the pump 36 to the reservoir 34. The continuous flow of cold water through the main feed line 14 and main return line 18 insures that cold water is quickly available to heat exchange garments 10 as they are attached to the fluid delivery system 9.

A user 41 connects the quick coupling connector 30 of the heat exchange garment 10 to a quick coupling connector 24 of the fluid delivery system 9 and adjusts the flow control valve 50 as desired. This opens a flow path for the cooling water that includes the heat exchange garment 10. The lengths of the branch feed line 20, the branch return line 22, and the tether portion 104 of the heat exchange garment 10, and the height at which the branch feed line 20 and branch return line 22 are affixed to the support member 48 are selected so that the branch feed line 20, the branch return line 22, and the tether portion 104 of the heat exchange garment 10 are supported above and do not drag along the ground 44. Cold water passes through the branch feed line 20 to the pressure regulator 46. The pressure regulator 46 reduces the pressure of water passing through the branch feed line 20 to a pressure that is preferably less than or equal to approximately 10 psig, that is more preferably approximately less than or equal to approximately 7 psig, and that is most preferably less than or equal to approximately 5 psig. The pressure regulator 46 also sets a maximum flow rate that may pass through the feed line to the heat exchange garment 10 that is substantially within a range that is preferably from approximately 1 gallon per hour to approximately 50 gallons per hour, that is more preferably from approximately 3 gallons per hour to approximately 20 gallons per hour, and that is most preferably from approximately 6 gallons per hour to approximately 12 gallons per hour.

Water passes from the pressure regulator 46, through the branch feed line 20, through the connectors 24 and 30, into the feed end of the cooling tube 28, and through the intermediate portion of the tube 28 so that the water is placed in a heat exchange relationship with a user 41 wearing the heat exchange garment 10. The water removes heat from the user 41, thereby cooling the user 41. After cooling the user 41, the warmed water passes through the return end of the tube 28, through connectors 30 and 24, and through the branch return line 22 to the main return line 18, where it is returned to the reservoir 34 for cooling. Using the flow control valve 50, the user 41 may adjust the flow rate passing through his or her heat exchange garment 10. The flow rate may be adjusted from 0 gallons per hour to the maximum flow rate allowed by the pressure regulator 46. As needed, the other five heat exchange garments 10 may be connected to or disconnected from the fluid delivery system 9 and may be adjusted by each individual user 41 as just discussed. As more water passes through each heat exchange garment 10, less water is passed through the back pressure regulator 38 and bypass line 40. Some of the benefits of this fluid delivery system 9 are the ease and flexibility in providing cooling fluid to sites or workstations that are disposed remotely from one another and the ease and convenience with which each individual 41 may control the flow rate through his or her own heat exchange garment 10 without the need to leave his or her particular site or workstation. This is true even though the different sites or workstations may be disposed remotely from the heat exchanger 12 and remotely from one another. In that regard, the flow control valve 50 attached to each branch return line 22 will typically be at least approximately 5 feet away from the heat exchanger 12 and will often be at least approximately 5 feet from another flow control valve 50.

The sizing and operation of a fluid delivery system of the present invention will vary greatly depending upon the desired use, demands upon, and desired characteristics of the system. For example, a 1.5 ton, 18,000 BTU chiller might be used to supply cooling fluid to up to 20 heat exchange garments 10 through a main feed line 14 that is up to approximately 300 feet long. For this system, a ½ hp pump 36 with a maximum flow rate of approximately 20 gallons per minute might be used. Similarly, a 3 ton, 36,000 BTU chiller might be used to supply cooling fluid to up to 40 heat exchange garments 10 through a main feed line 14 that is up to approximately 400 feet long. For this system, a ½ hp pump 36 with a maximum flow rate of approximately 20 gallons per minute might be used. As another example, a 5 ton, 60,000 BTU chiller might be used to supply cooling fluid to up to 80 heat exchange garments 10 through a main feed line 14 that is up to approximately 1,000 feet long. For this system, a ½ hp or ¾ hp pump 36 with a maximum flow rate of approximately 20 gallons per minute might be used. The above examples relate to a few common, commercially available chillers. It is of course understood that the fluid delivery system may take any number of different sizes and can be sized much smaller or much larger than these examples.

As seen in the alternate embodiment depicted in FIG. 8, a number of separate fluid delivery systems 9A and 9B may be used, particularly for a situation in which one workstation may be cold while another workstation in the same general area may be hot. For example, on an aircraft such as a C-130, the area near the rear of the aircraft may be cold, so that people working near the rear of the aircraft may need to be warmed. At the same time, an enclosed, restricted area in another part of the aircraft may be hot, so that people working in the enclosed, restricted area may need to be cooled. Depending upon the time of year and, more particularly, the climate and location in which the aircraft is operating, this situation may quickly become reversed. In a situation such as this, separate hot and cold fluid delivery systems may be used, with connectors 24A and 24B for both the hot and cold systems being available at a plurality of sites or workstations. In such a system, one or more connectors 24A to a hot fluid delivery system and one or more connectors 24B to a cold fluid delivery system are provided at multiple sites throughout the aircraft. The systems are operated independently of each other in a manner very similar to the example discussed above. As needed, a user 41 with a heat exchange garment 10 may plug the connector 30 of the heat exchange garment into a connector 24A that delivers hot fluid or into a connector 24B that delivers cold fluid. In that regard, the temperature of the fluid in the reservoir 34 of the hot fluid delivery system 9A and the temperature of the fluid in the reservoir 34 of the cold fluid delivery system 9B are selected so that there is a temperature difference between the two that is preferably greater than or equal to approximately 10° F., that is more preferably greater than or equal to approximately 25° F., and that is most preferably greater than or equal to approximately 50° F. The water in the reservoir 34 of the cold fluid delivery system 9B is preferably maintained at a temperature that is preferably substantially within a range of from approximately 80° F. to approximately 33° F., that is more preferably substantially within a range of from approximately 70° F. to approximately 40° F., and that is most preferably substantially within a range of from approximately 50° F. to approximately 45° F. Similarly, the water in the reservoir 34 of the hot fluid delivery system 9A is preferably maintained at a temperature that is preferably substantially within a range of from approximately 81° F. to approximately 120° F., that is more preferably substantially within a range of from approximately 95° F. to approximately 115° F., and that is most preferably substantially within a range of from approximately 105° F. to approximately 110° F. Connectors 24A and 24B from the hot and cold fluid delivery systems 9A and 9B may be identified in any number of different ways, including labeling and color-coding. For example, connectors 24A for the hot fluid delivery system 9A may be red, and connectors 24B for the cold fluid delivery system 9B may be blue.

There is a great deal of flexibility in sizing a fluid delivery system 9 of the present invention. For example, in most applications it is preferred that the heat exchanger 12 be capable of continuously meeting or exceeding the maximum loads that may be placed on the fluid delivery system 9 for extended periods of time. Still, in some applications, this may not be the case. For example, in a mobile setting, such as when a fluid delivery system is used in a mobile application such as in or on a fishing boat, golf cart, backpack, or the like, the desire for less weight and lower cost may make it more desirable to provide a smaller heat exchanger 12. In such a situation, a heat exchanger 12, such as a small chiller may be used in combination with ice or some other cold bank to delay the depletion of that bank. For example, on a golf cart or a fishing boat, an insulated reservoir may carry ice and water. A 12 volt, 600 BTU chiller may be used and placed in a heat exchange relationship with the ice and water in the insulated reservoir. Similar to the systems described above, the fluid delivery system might include a pump 36, and some combination of main feed and return lines 14 and 18 and branch feed and return lines 20 and 22, if needed, to supply one or more connectors 24 capable of delivering the cooling fluid to one or more heat exchange garments 10. While the small chiller may not be able to match the maximum load that may be placed on the fluid delivery system 9, it will at least partially offset that load and can therefore significantly prolong the life of the ice and thereby significantly delay the depletion of the cold bank and the need to replace the ice. In this manner, a single charge of ice may last an entire day as opposed to lasting for only an hour or so. For quicker recharging, new ice may be placed in the insulated container. If quick recharging is not required, the small chiller may be operated for prolonged periods in which no load or low loads are placed on the system, such as overnight, to freeze water in the reservoir.

Other modifications, changes and substitutions are intended in the foregoing, and in some instances, some features of the invention will be employed without a corresponding use of other features. For example, the heat exchanger 12 may be immobile, substantially immobile, or portable. The lines and tubes may be formed from any of number of different materials and may take any number of different shapes, sizes, and lengths. Any number of different connectors 24 and 30 may be used, including but not limited to quick coupling connectors, or the heat exchange garments 10 may be connected directly to feed and discharge lines. Further, the flow control valves 16 and 50 and pressure regulators 46 may or may not be used and may be positioned in any number of different places. For example, the pressure regulator 46 and/or the flow control valve 50 may be disposed in the tether portion 104 of the heat exchange garment 10. Further still, the fluid delivery system 9 may be used with or without a powered heat exchanger 12 and with or without hot or cold banks such as ice. Any number of different configurations of support members 48 may be used, or the system may be used without support members 48. Although it is preferred to support the feed and return lines off the ground 44, they may be allowed to touch or rest on the ground 44. Of course, quantitative information is included by way of example only and is not intended as a limitation as to the scope of the invention. Accordingly, it is appropriate that the invention be construed broadly and in a manner consistent with the scope of the invention disclosed.

What is claimed is:

1. A combination, comprising:
a heat exchanger;
a first flow control valve disposed remotely from said heat exchanger;
a main feed line operably connecting said heat exchanger and said first flow control valve, said main feed line having a first length that is greater than or equal to approximately 12 feet;
a main return line operably connecting said first flow control valve to said heat exchanger;
a first heat exchange garment;
a first branch feed line operably connecting said first main line to said first heat exchange garment;
a first branch return line operably connecting said first heat exchange garment to said main return line;
a second heat exchange garment;
a second branch feed line operably connecting said main feed line to said second heat exchange garment; and
a second branch return line operably connecting said second heat exchange garment to said main return line.

2. The combination of claim 1, wherein said first flow control valve is disposed a first distance from said heat exchanger, said first distance being greater than or equal to approximately 15 feet.

3. The combination of claim 1 wherein said main feed line has an elevated portion, said elevated portion of said main feed line having a length that is greater than or equal to approximately 5 feet, said elevated portion of said main feed line being disposed at a height that is greater than or equal to approximately 5 feet.

4. The combination of claim 1, wherein said main feed line has an elevated portion, said elevated portion of said main feed line having a length that is greater than or equal to approximately 20 feet, said elevated portion of said main feed line being disposed at a height that is greater than or equal to approximately 6 feet.

5. The combination of claim 1, further comprising:
a first pressure regulator, said first pressure regulator being operably connected to said first branch feed line.

6. The combination of claim 1, further comprising:
a second flow control valve, said second flow control valve being operably connected to said first branch return line.

7. The combination of claim 1, further comprising:
a second flow control valve, said second flow control valve being operably connected to said first branch return line: and
a third flow control valve, said third flow control valve being operably connected to said second branch return line, said second flow control valve being disposed at least approximately five feet away from said heat exchanger and at least approximately five feet away from said third flow control valve.

8. The combination of claim 1, further comprising:
a first support member, said first support member having an elevated portion, said elevated portion of said first support member being disposed at a height that is greater than or equal to approximately 5 feet; said first branch feed line and said first branch return line being affixed to said elevated portion of said first support member.

9. The combination of claim 8, wherein said first support member comprises a substantially stationary section and a movable section rotatably secured to said stationary section.

10. The combination of claim 9, wherein said movable section comprises an elongate member, said elongate member being rotatable about a substantially vertical axis.

11. The combination of claim 9, wherein said movable section comprises a reel.

12. The combination of claim 1, wherein said heat exchange garment comprises:
a material adapted to be worn by or placed on a user;
a connector; and
a tube, said tube comprising a feed end, a return end, and an intermediate portion; said feed end and said return end being affixed to said connector, and said intermediate portion being affixed to said material.

13. A method comprising:
(a) providing a heat exchanger, a main feed line, and a main return line;
(b) continuously circulating a fluid through said heat exchanger, said main feed line, and said main return line, said fluid having a first maximum pressure in said main feed line that is greater than or equal to approximately 15 psig and having a second maximum pressure in said main return line that is less than or equal to approximately 10 psig;
(c) withdrawing a first portion of said fluid from said main feed line;
(d) reducing pressure of said first portion of said fluid to a third pressure, said third pressure being less than or equal to approximately 10 psig;
(e) after step (d), passing said first portion of said fluid through a first heat exchange garment; and
(f) after step (e), passing said first portion of said fluid to said main return line.

14. The method of claim 13, further comprising:
(g) withdrawing a second portion of said fluid from said main feed line;
(h) reducing pressure of said second portion of said fluid to a fourth pressure, said fourth pressure being less than or equal to approximately 10 psig;
(i) after step (h), passing said second portion of said fluid through a second heat exchange garment; and
(j) after step (i), passing said second portion of said fluid to said main return line.

15. The method of claim 13, wherein said first maximum pressure is greater than or equal to approximately 25 psig and said second maximum pressure is less than or equal to approximately 8 psig.

16. The method of claim 13, further comprising:
providing a first flow control valve, disposed remotely from said heat exchanger; and
adjusting said first flow control valve to increase or decrease a flow rate of said first portion of said fluid withdrawn from said main feed line.

17. The method of claim 16, further comprising:
providing a second flow control valve, disposed remotely from said heat exchanger and remotely from said first control valve; and
adjusting said second flow control valve to increase or decrease a flow rate of said second portion of said fluid withdrawn from said main feed line.

18. The method of claim 17, wherein said second flow control valve is disposed at least approximately 5 feet from said heat exchanger and at least approximately 5 feet from said first flow control valve.

19. A method, comprising:
providing first and second connectors at a first site;
providing a first portion of a first fluid at or above a first temperature to said first connector;
providing a first portion of a second fluid at or below a second temperature to said second connector, said first temperature being at least approximately 10° F. higher than said second temperature;
providing a first heat exchange garment; and
connecting said first heat exchange garment to said first connector or said second connector so that said first portion of said first fluid or said first portion of said second fluid flows through said first heat exchange garment.

20. The method of claim 19, wherein said first temperature is greater than or equal to approximately 90° F. and said second temperature is less than or equal to approximately 70° F.

21. The method of claim 19, wherein said first temperature is greater than or equal to approximately 100° F. and said second temperature is less than or equal to approximately 60° F.

22. The method of claim 19, further comprising:
providing third and fourth connectors at a second site;
providing a second portion of said first fluid at or above said first temperature to said third connector;
providing a second portion of said second fluid at or below said second temperature to said fourth connector;
providing a second heat exchange garment; and
connecting said second heat exchange garment to said third connector or said fourth connector so that said second portion of said first fluid or said second portion of said second fluid flows through said second heat exchange garment.

23. The method of claim 22, wherein said first site comprises a first workstation on an aircraft and said second site comprises a second workstation on said aircraft.

24. The method of claim 23, wherein said aircraft comprises a C-130 aircraft.

25. A combination, comprising:
a first support member, said first support member having an input opening for receiving a fluid from a fluid source and a discharge opening for returning said fluid to said fluid source;
a rotating support member, said rotating support member being rotatably secured to said first support member, said rotating support member having a first opening on an outer surface and having a second opening on said outer surface, said first support member and said rotating support member defining a feed path extending between said input opening of said first support member and said first opening of said rotating support member, and said first support member and said rotating support member defining a return path extending between said discharge opening of said first support member and said second opening of said rotating support member;
a first connector;
a first feed line extending between said first opening of said rotating support member and said first connector;
a first return line extending between said second opening of said rotating support member and said first connector; and
a first heat exchange garment operably connected to said first connector.

26. The combination of claim 25, wherein said rotating support member further comprises an elongate member extending outwardly from said first and second openings of said rotating support member, said first feed line and said first return line being affixed to said elongate member.

27. The combination of claim 25, further comprising a pressure regulator affixed to said first feed line and a flow control valve affixed to said first return line.

28. The combination of claim 25, further comprising:
a second connector;
a second feed line operably connecting said fluid source and said second connector;
a second return line operably connecting said fluid source and said second connector; and
a second heat exchange garment operably connected to said second connector.

29. The combination of claim 25, further comprising a forklift, said first support member being rigidly secured to said forklift.
